(19) United States
(12) Patent Application Publication
(10) Pub. No.: US 2009/0110324 A1
(43) Pub. Date: Apr. 30, 2009

(54) White/black pixel correction in a digital image sensor

(76) Inventors: Hongjun Li, San Jose, CA (US); Yuqian Dong, San Jose, CA (US); Xinping He, San Jose, CA (US)

Correspondence Address: BLAKELY SOKOLOFF TAYLOR & ZAFMAN LLP, 1279 Oakmead Parkway, Sunnyvale, CA, 94085-4040, US

(21) Appl. No.: 11/981,004

(22) Filed: Oct. 30, 2007

(51) Int. Cl. G06K 9/40

(52) U.S. Cl. 382/275

(57) ABSTRACT

Disclosed are embodiments of an apparatus comprising an image sensor comprising a pixel array including a plurality of pixels, a detection circuit coupled to the pixel array to detect potential white/black pixel defects in the pixel array, a correction circuit coupled to the detection circuit to correct potential white/black pixel defects detected by the detection circuit. The apparatus further comprises a digital signal processor coupled to the image sensor, the digital signal processor comprising a memory to have therein a list of defective pixels in the pixel array, and a processor coupled to the memory to cross-check each pixel against the list of defective pixels and correct the digital value of each pixel found in the list of defective pixels. Other embodiments are disclosed and claimed.

### TECHNICAL FIELD

The present invention relates generally to image sensors and in particular, but not exclusively, to white/black pixel defect correction in an image sensor.

### BACKGROUND

Recent manufacturing improvements in semiconductor processing have markedly reduced the number of defects that occur in any given semiconductor device, but limitations inherent in every manufacturing process make it impossible to completely eliminate defects. Therefore, no matter how good the manufacturing process, defects continue to exist in finished semiconductor devices. If a defect is severe, the resulting device must often be thrown away, resulting in decreased yield and increased cost. But if the defect is minor, it can often be compensated for by circuitry or logic running on the semiconductor device itself or by back-end processing of signals from the semiconductor device.

In image sensors, a common type of manufacturing defect is known as a white/black pixel defect. Image sensors typically include an array of individual pixels that gather charge as a result of light incident on the pixels. White/black pixel defects occur when a particular pixel outputs a signal that is substantially different than the signals output by other nearby pixels. Thus, if a particular pixel outputs a signal corresponding to the color black (i.e., a very low intensity signal) but some or all of the surrounding pixels output signals that correspond to the color white (i.e., a very high intensity signal), the likely cause is some defect in the pixel outputting the low-intensity signal.

Fortunately, unless there is a large cluster of contiguous defective pixels, white/black pixel defects can be compensated for. Existing methods of compensating for white/black pixel defects, however, are slow and inefficient and use computational resources, thereby slowing the image capture by the image sensor and reducing its performance.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic block diagram of an embodiment of a white/black pixel correction apparatus.

FIG. 2 is a flowchart of an embodiment of a process for calibrating a white/black pixel correction apparatus such as the one shown in FIG. 1.

FIG. 3 is a flowchart illustrating an embodiment of a process for operating a white/black pixel correction apparatus such as the one shown in FIG. 1.

FIG. 4 is a schematic block diagram of an embodiment of an imaging system that uses a white/black pixel correction apparatus such as the one shown in FIG. 1.

### DETAILED DESCRIPTION OF THE ILLUSTRATED EMBODIMENTS

Embodiments of an apparatus, system and process for white/black pixel correction in an image sensor are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

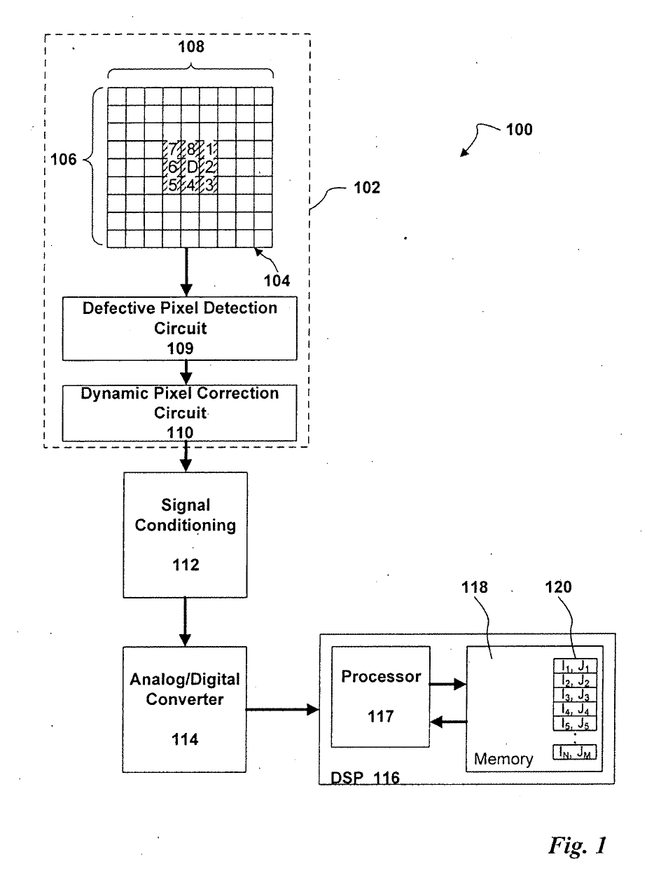

FIG. 1 illustrates an embodiment of an apparatus 100 for white/black pixel correction. Apparatus 100 includes an image sensor 102 comprising a pixel array 104 and a dynamic pixel correction circuit 110. Pixel array 104 is two-dimensional and includes a plurality of pixels arranged in rows 106 and columns 108. During operation of pixel array 104 to capture an image, each pixel in the array captures incident light (i.e., photons) during a certain exposure period and converts the collected photons into an electrical charge. The electrical charge generated by each pixel can be read out as an analog signal, and a characteristic of the analog signal such as its charge, voltage or current will be representative of the intensity of light that was incident on the pixel during the exposure period.

The illustrated pixel array 104 is regularly shaped, but in other embodiments the array can have a regular or irregular arrangement different than shown and can include more or less pixels, rows and columns than shown. Moreover, in different embodiments pixel array 104 can be a color image sensor including red, green and blue pixels designed to capture images in the visible portion of the spectrum, or can be a black-and-white image sensor and/or an image sensor designed to capture images in the invisible portion of the spectrum, such as infra-red or ultraviolet.

After an image is captured using pixel array 104, one or more of the pixels in the array may exhibit a potential white/black pixel defect. Whether a given pixel exhibits a potential white/black pixel defect is determined by comparing the intensity of the signal from that pixel with the intensity of the signals from at least one of its surrounding pixels. Thus, within pixel array 104, pixel D has a potential white/black pixel defect if its intensity is significantly different than one or more of surrounding pixels 1-8. Pixel D is said to have a potential white/black pixel defect because, under some circumstances, the difference in intensity between pixel D and surrounding pixels 1-8 may not actually be a defect, but rather may be a true attribute of the image captured by pixel array 104. For example, if pixel array 104 is used to capture an image of an object that has abrupt and/or high-frequency changes between light and dark areas, it is possible that the discrepancy between pixel D and its surrounding pixel is an accurately captured characteristic of the scene and not the result of a defect.

Defective pixel detection circuit 109 is coupled to pixel array 104 and includes circuitry and associated logic to receive output from each of the individual pixels within pixel array 104. Defective pixel detection circuit 110 analyzes the analog input from pixel array 104 to detect potential white/black pixel defects. Defective pixel detection circuit 109 determines the existence of a potential white/black pixel by comparing the intensity of the signal from that pixel with the intensity of the signals from at least one of its surrounding pixels. Thus, within pixel array 104, pixel D has a potential white/black pixel defect if its intensity is significantly different than one or more of surrounding pixels 1-8.

Dynamic pixel correction circuit 110 is coupled to defective pixel detection circuit 109 and uses circuitry and logic found therein to attempt to correct the potential white/black pixel defects identified by defective pixel detection circuit 109. The correction applied by dynamic pixel correction circuit 110 can be done differently in different embodiments. In one embodiment, the value of pixel D is corrected by replacing it with the value of one of its adjacent pixels 1-8. Other embodiments can have more complex correction schemes. For example, in one embodiment a value pixel of D might be interpolated from the values of some or all of surrounding pixels 1-8 using a linear interpolation or some higher-order interpolation. In another example, the value of pixel D can be replaced with an average or weighted average of surrounding pixels 1-8. In still other embodiments, pixel D can be corrected based on pixels other than or in addition to adjacent pixels 1-8. In some embodiments, dynamic pixel correction circuit 110 has no way of knowing whether a given pixel D is truly defective. Thus, in one embodiment dynamic pixel correction circuit 110 applies a correction to every potentially defective pixel D, whether truly defective or not.

Although shown in the drawing as an element separate from pixel array 104, in some embodiments dynamic pixel correction circuit 110 can be integrated with pixel array 104 on the same substrate or can comprise circuitry and logic within the pixel array. In other embodiments, however, dynamic pixel correction circuit 110 can be an element external to pixel array 104 as shown in the drawing. In still other embodiments, dynamic pixel correction circuit can be a element not only external to pixel array 104, but also external to image sensor 102.

Signal conditioner 112 is coupled to image sensor 102 to receive and condition analog signals from pixel array 104 and Dynamic pixel correction circuit 110. In different embodiments, signal conditioner 112 can include various components for conditioning analog signals. Examples of components that can be found in signal conditioner include filters, amplifiers, offset circuits, automatic gain control, etc.

Analog-to-digital converter (ADC) 114 is coupled to signal conditioner 112 to receive conditioned analog signals corresponding to each pixel in pixel array 202 from signal conditioner 112 and convert these analog signals into digital values.

Digital signal processor (DSP) 116 is coupled to analog-to-digital converter 114 to receive digitized pixel data from ADC 114 and process the digital data to produce a final digital image. DSP 116 includes a processor 117 that can store and retrieve data in a memory 118, within can be stored a data structure 120 that includes information about pixels within pixel array 104 that are known to be defective. In the illustrated embodiment memory 118 is integrated within DSP 116, but in other embodiments memory 118 can be a separate element coupled to DSP 116. Processor 117 can perform various functions, including processing pixel, cross-checking pixels against pixels whose pixel identifier is in data structure 120, and so forth.

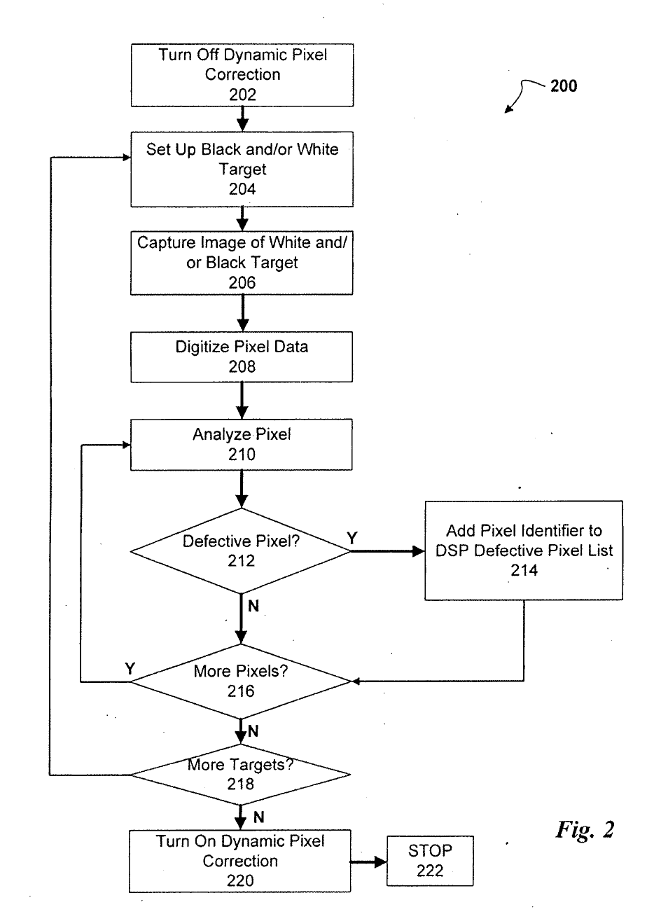

Data structure 120 can be any kind of data structure capable of holding the required pixel data; the exact kind of data structure used will depend on the operational requirements set for apparatus 100. In one embodiment data structure 120 can be a look-up table, but in other embodiments data structure 120 can be something more complex such as a database. The defective pixels listed in data structure 120 are identified by the locations of the defective pixels within pixel array 104. In the illustrated embodiment, defective pixels are identified in data structure 120 by a pixel identifier that includes a pair of numbers I and J that denote the defective pixel's row and column within pixel array 104. In other embodiments, however, other ways can be used in data structure 120 to identify defective pixels. For example, in an embodiment where pixel array 104 has individually addressable pixels data structure 120 can contain the addresses of the defective pixels instead of their row/column coordinates (I,J) within the pixel array. The entries in data structure 120 can be generated during an initial calibration of apparatus 100, as described below in connection with FIG. 2.

FIG. 2 illustrates an embodiment of a process 200 for calibrating a white/black pixel defect correction apparatus 100 such as the one shown in FIG. 1. Starting at block 202, the dynamic pixel correction, implemented by dynamic pixel correction block 110 in the embodiment of FIG. 1, is turned off so that it will not correct or attempt to correct any potentially defective pixels during calibration. At block 204 a uniformly black target or a uniformly white target is set up so that an image of the target can be captured by pixel array 104 within image sensor 102. In one embodiment the entire calibration 200 can initially be done with a white target and then repeated with a black target, or vice versa, but in other embodiments the calibration can be done with only one of a white target or a black target. At block 206 an image of the target is captured by image pixel array 104, and at block 208 the analog pixel data from the pixel array is digitized.

At block 210 the digital values of individual pixels are analyzed to spot defective pixels. In one embodiment, to spot defective pixels the value of each pixel is compared to adjacent pixels. Because the target whose image was captured is either uniformly black or uniformly white, the digital values for the all pixels in pixel array 104 should be the same. If there is a big discrepancy between a pixel's digital value and the digital values of its adjacent pixels, then the pixel in question is almost certainly defective. Thus if a pixel's value is substantially higher than one or more of its adjacent pixels (for a calibration using a uniformly black target) or substantially lower than one or more of its adjacent pixels (for a calibration using a uniformly white target), that pixel is deemed defective. In other embodiments other methods for determining whether a pixel is defective can be used.

If as a result of the pixel analysis of block 210 a defective pixel is found at block 212, then at block 214 the location of the defective pixel is added to the data structure 120 within DSP 116. In one embodiment the location of the defective pixel is noted by placing its pixel identifier—in one embodiment, the row and column coordinates of the pixel—into a look up table of defective pixels, but in other embodiments it can be done differently as described above. After the location of a defective pixel is added to data structure 120 at block 214, as block 216 the process checks whether there are more pixels to be analyzed. If there are, the process returns to block 210 and analyzes the next pixel; if there are not (i.e., if all pixels in pixel array 104 have been analyzed), the process proceeds to block 218 where the calibration checks to see whether there are more calibration targets to be used for the calibration; as noted above, if the initial calibration was carried out with a black target it can be repeated with a white target, or vice versa, to identify more defective pixels.

If at block 218 another target is to be used for calibration, the process returns to block 204, where the new target is set up, and proceeds through blocks 206-216 for the new target. If at block 218 there are no additional calibration targets, the process moves to block 220 where the dynamic pixel correction is turned back on so that it can correct any potentially defective pixels during operation. The process then proceeds to block 222, where the calibration stops.

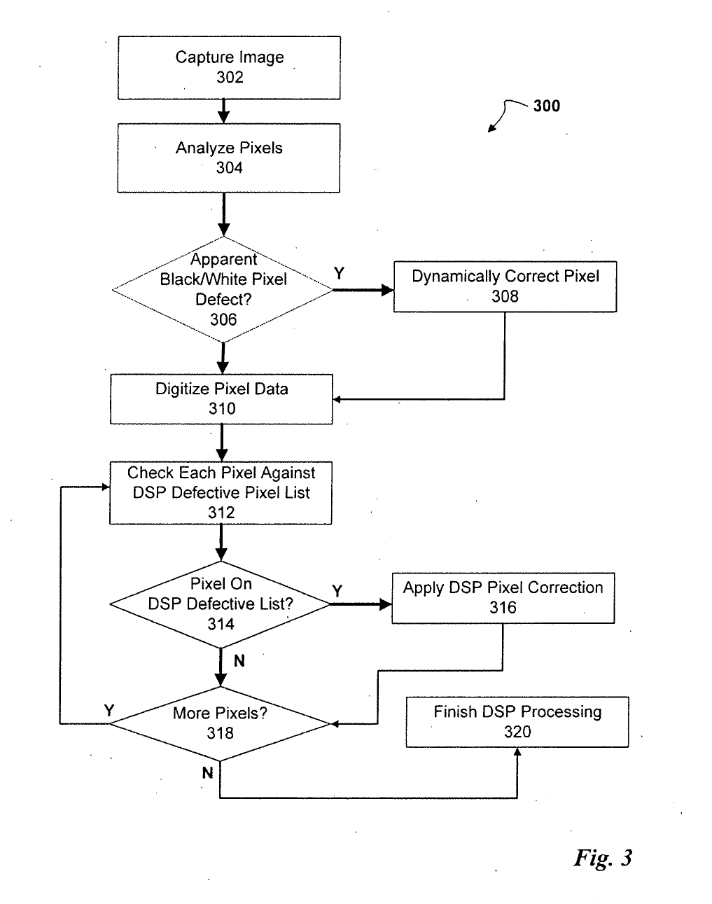

FIG. 3 illustrates an embodiment of a process 300 for operating a white/black pixel defect correction apparatus 100 such as the one shown in FIG. 1. At block 302, image sensor 102 is used to capture an image of some scene or object. After the image capture at block 302, at block 304 the dynamic pixel correction block 110 analyzes the analog signals from the individual pixels within pixel array 104 to identify potential white/black pixel defects. If as a result of the pixel analysis at block 304 a potentially white/black defective pixel is found at block 306, then at block 308 the potentially defective pixel is corrected by dynamic pixel correction circuit 110 as described above.

At block 310 the analog pixel data received from image sensor 102 is digitized. After the pixel data is digitized, at block 312 each pixel's pixel identifier is cross-checked against the pixel identifiers in data structure 120 to see whether it is identified as a defective pixel. If as a result of cross-checking a pixel at block 312 a defective pixel is found at block 314, then at block 316 the defective pixel is corrected by DSP 116 as described above. At block 318 the process checks whether there are any pixels left that have not been cross-checked against the defective pixels listed in data structure 120 and corrected if necessary. If at block 318 there are pixels left that have not been cross-checked, the process returns to block 312 and cross-checks any remaining pixels. If at block 318 there a no pixels left to cross-check, the process proceeds to block 320, where processing by DSP 116 is finished.

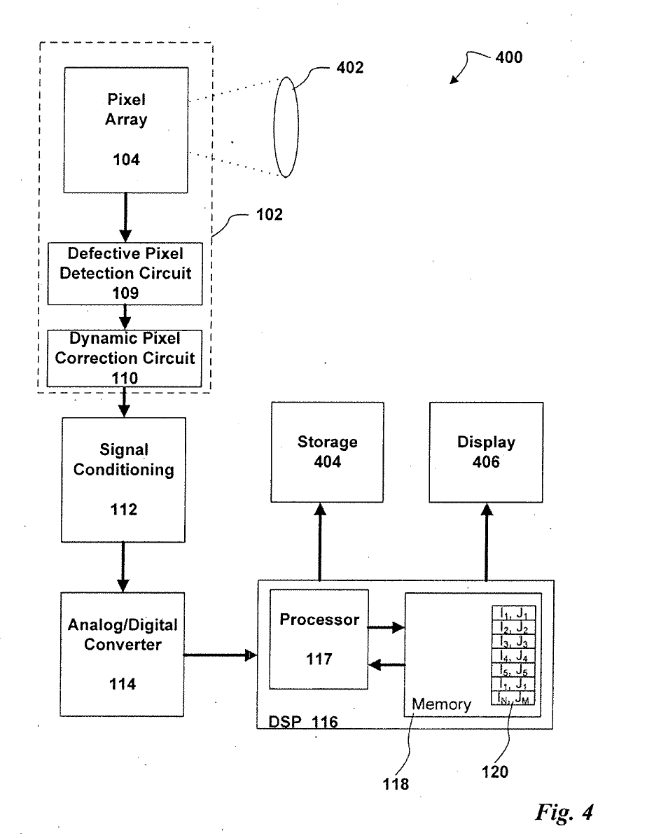

FIG. 4 illustrates an embodiment of an imaging system 400 employing a white/black pixel correction apparatus such as white/black pixel correction apparatus 100 described in FIG. 1. Optics 402, which can include refractive, diffractive or reflective optics or combinations of these, are coupled to image sensor 102 to focus an image onto the pixels in pixel array 104. Pixel array 104 captures the image and the remainder of apparatus 100 processes the pixel data from the image as described above in connection with FIGS. 1 and 3. Once any defective pixel data has been corrected, the final digital image data can be output from DSP 118 to one or both of a display unit 406 and a memory or storage unit 408.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus comprising:
an image sensor comprising:
a pixel array including a plurality of pixels,
a detection circuit coupled to the pixel array to detect potential white/black pixel defects in the pixel array, and
a correction circuit coupled to the detection circuit to correct potential white/black pixel defects detected by the detection circuit; and
a digital signal processor coupled to the image sensor, the digital signal processor comprising:
a memory to have therein a list of defective pixels in the pixel array, and
a processor coupled to the memory to cross-check each pixel against the list of defective pixels and correct the digital value of each pixel found in the list of defective pixels.

2. The apparatus of claim 1 wherein the list of defective pixels is kept in a data structure in the digital signal processor.

3. The apparatus of claim 2 wherein the data structure is a look-up table.

4. The apparatus of claim 1 wherein detecting a potential white/black pixel defect comprises comparing the intensity of a pixel to the intensity of at least one adjacent pixel.

5. The apparatus of claim 4 wherein correcting a potential white/black pixel defect comprises replacing the analog value of the potentially defective pixel with an analog value based on the analog value of at least one adjacent pixel.

6. The apparatus of claim 1, further comprising an analog-to-digital converter coupled to the image sensor and to the digital signal processor.

7. The apparatus of claim 6, further comprising a signal conditioner coupled to the image sensor and to the analog-to-digital converter.

8. A process comprising:
identifying pixels within a pixel array having a potential white/black pixel defect;
correcting the pixels having a potential white/black pixel defect;
cross-checking each pixel against a list of defective pixels; and
correcting the digital value of each pixel found on the list of defective pixels.

9. The process of claim 8 wherein identifying pixels having a potential white/black pixel defect comprises comparing the intensity of the analog signal from each pixel to the intensity of the analog signal from at least one adjacent pixel.

10. The process of claim 8 wherein correcting a potential white/black pixel defect comprises replacing the analog value of the pixel with an analog value based on the analog value of at least one adjacent pixel.

11. The process of claim 1 wherein cross-checking against list of defective pixels comprises searching for a pixel identifier in a data structure.

12. The process of claim 11 wherein the data structure is a look-up table.

13. A system comprising:
an optical element;
an image sensor comprising:
a pixel array including a plurality of pixels,
a detection circuit coupled to the pixel array to detect potential white/black pixel defects in the pixel array, and
a correction circuit coupled to the detection circuit to correct potential white/black pixel defects detected by the detection circuit; and
a digital signal processor coupled to the image sensor, the digital signal processor comprising:
a memory to have therein a list of defective pixels in the pixel array, and
a processor coupled to the memory to cross-check each pixel against the list of defective pixels and correct the digital value of each pixel found in the list of defective pixels; and
one or both of a display unit and a storage unit coupled to the digital signal processor.

14. The system of claim 13 wherein the list of pixels known to be defective is kept in a data structure in the digital signal processor.

15. The system of claim 14 wherein the data structure is a look-up table.

16. The system of claim 13 wherein detecting a potential white/black pixel defect comprises comparing the intensity of a pixel to the intensity of at least one adjacent pixel.

17. The system of claim 13 wherein correcting a potential white/black pixel defect comprises replacing the analog value of the pixel with an analog value based on the analog value of at least one adjacent pixel.

18. The system of claim 13, further comprising an analog-to-digital converter coupled to the image sensor and to the digital signal processor.

19. The system of claim 18, further comprising a signal conditioner coupled to the image sensor and to the analog-to-digital converter.

20. The system of claim 13 wherein the optical element comprises one or more of a refractive, a diffractive optical element or a reflective optical element.
